(19) United States
(12) Patent Application Publication
(10) Pub. No.: US 2010/0280726 A1
(43) Pub. Date: Nov. 4, 2010

(54) PREVENTION OF A REAR CRASH DURING AN AUTOMATIC BRAKING INTERVENTION BY A VEHICLE SAFETY SYSTEM

(76) Inventor: Stephan Stabrey, Stuttgart (DE)

Correspondence Address: KENYON & KENYON LLP, ONE BROADWAY, NEW YORK, NY, 10004, US

(21) Appl. No.: 12/596,922

(22) PCT Filed: Feb. 29, 2008
(86) PCT No.: PCT/EP2008/052468

§ 371 Date: Jun. 23, 2010

(30) Foreign Application Priority Data
Apr. 27, 2007 (DE) 102007019991.2

(51) Int. Cl. B60T 8/17

(52) U.S. Cl. 701/70

(57) ABSTRACT

A method for preventing a rear crash after the activation of an automatic braking intervention by a vehicle safety system. The danger and severity of a possible rear crash by a vehicle following behind can be significantly reduced if a model is used for the approach of a hypothetical vehicle following behind, and on this basis a condition is determined for the release of the brake, and the brake is at least partially released when this condition occurs.

### FIELD OF THE INVENTION

The present invention relates to a method for preventing a rear crash after activation of an automatic braking intervention by a vehicle safety system, as well as to a control device having a braking algorithm.

### BACKGROUND INFORMATION

From the prior art, various vehicle safety systems are known that, in critical driving situations in which the vehicle is for example approaching an obstacle, introduce an automatic emergency braking (ANB). Such collision prevention systems standardly include a “look-ahead” sensor system that monitors the area in front of the vehicle and that automatically activates the driving brake when there is a threat of a frontal collision with another object. Depending on the driving situation, a full braking may also be carried out here. In addition, safety systems are also known that, after an initial collision, introduce an automatic emergency braking in order to reduce the severity of possible subsequent collisions. In interventions of this type, there is always the danger that a vehicle following behind, or its driver, will not be able to brake quickly enough, so that a rear crash will occur due to insufficient safety distance.

### SUMMARY OF THE INVENTION

An object of the present invention is therefore to reduce the danger of a rear crash by a vehicle following behind in the case of an automatic emergency braking.

An important aspect of the present invention is that an automatic braking intervention is carried out under the assumption of a hypothetical vehicle following behind that is approaching the home vehicle in a particular, theoretically assumed manner, and to carry out the braking in such a way that no rear crash, or only a very mild rear crash, occurs. According to the present invention, at the beginning of the automatic braking intervention a strong braking is carried out with a high braking moment, and in a second phase the brake is at least partially released in order to reduce the danger or severity of the rear crash. In this context, the time for the release of the brake is determined in particular by the initial distance and the theoretically assumed behavior of the vehicle following behind. The use of a model for the approach of the vehicle following behind has the advantage that no sensor system is necessary in order to monitor the area behind the vehicle. However, the brake is released during an automatic braking even if there is no vehicle following behind the home vehicle. Therefore, in the design of the system a compromise is to be found between the safety of the home vehicle and that of the vehicle following behind.

The condition for release of the brakes of the vehicle traveling in front is preferably a function of the assumed initial distance of the vehicle following behind from the home vehicle, of the initial speed of the vehicle following behind, of a theoretical reaction time of the driver of the vehicle following behind, and/or of a theoretically possible deceleration of the vehicle following behind.

For the initial distance from the vehicle following behind, the rule of thumb “half speed,” or some arbitrary multiple of the speed of the home vehicle, may for example be used. The assumed distance of the vehicle following behind is preferably a function of speed. For the initial speed of the vehicle following behind, for example the speed of the home vehicle may be assumed, or some arbitrary multiple thereof, and for the deceleration a fraction, e.g. 80%, of the deceleration of the vehicle traveling in front may be assumed.

In order to determine the release time, an algorithm is preferably provided that takes into account one or more of the named quantities. Instead of an analytic algorithm, of course a corresponding function or set of curves can also be stored in the system that defines the desired braking function. Both variants are to be understood as referred to here by the designation “model.”

According to a preferred specific embodiment of the present invention, an algorithm is provided that, during an automatic emergency braking, calculates a speed (release speed) for the front vehicle at which the vehicle brake must automatically be released. Of course, optionally it would also be possible for a different release condition, such as a concrete point in time or a particular theoretically assumed distance from the vehicle following behind, to be determined as the release condition. However, the release speed can be measured relatively simply and precisely using the wheel rotational speed sensors. In the case of a braking function stored in the system, this function preferably specifies a release speed beginning from which the vehicle brake is to be released. In this context, the release speed is a function in particular of the initial speed of the home vehicle.

For the determination of the release condition, it is assumed that after the release of the brake a certain distance between the two vehicles is not undershot, or, for the case in which two vehicles are in contact, a particular speed difference should not be exceeded. According to a preferred specific embodiment of the present invention, the condition is selected such that at the point in time at which the two vehicles contact each other the speed difference is equal to zero.

A vehicle system according to the present invention includes a control device that is connected to an environmental sensor system and that has an algorithm that operates as described above.

In the case of a collision prevention system, the system includes a “look-ahead” sensor system that monitors the area in front of the vehicle and that automatically activates the driving brake when there is the threat of a frontal collision with another object. In the case of a safety system that introduces an automatic emergency braking after an initial collision, the control device is equipped for example with acceleration sensors, or obtains the information about a collision from the airbag system.

### BRIEF DESCRIPTION OF THE DRAWINGS

FIG. 1 shows a schematic representation of two vehicles moving at a specified distance.

FIG. 2a shows the temporal curve of the acceleration of the two vehicles.

FIG. 2b shows the temporal curve of the speed of the two vehicles.

FIG. 2c shows the temporal curve of the distance between the two vehicles.

FIG. 3 shows a schematic functional plan for calculating the activation condition.

### DETAILED DESCRIPTION

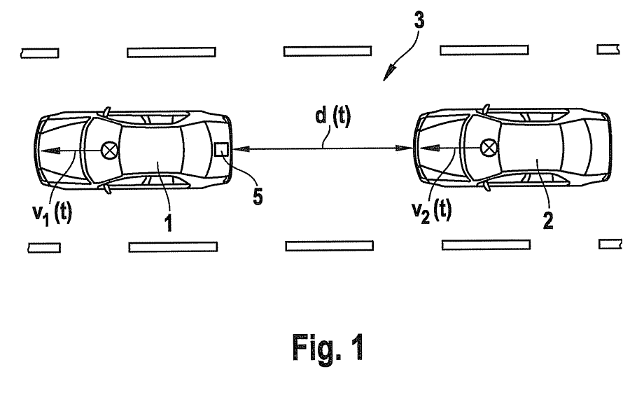

FIG. 1 shows two vehicles 1, 2 that are moving on a roadway 3 with a speed v₁(t) or v₂(t) respectively. The distance between the two vehicles is designated d(t).

At least front vehicle 1 has a vehicle safety system 5 that is capable of introducing an automatic emergency braking in certain driving situations, e.g. when there is the threat of a frontal collision, or after an initial collision. The overall system, including the sensors and the control device, is here represented schematically as block 5.

Upon recognition of a critical situation, an automatic braking is activated, and the vehicle brakes are at first actuated with a high braking force. Beginning from a particular point in time, the brakes are then at least partially released in order to reduce the danger or severity of a threatening rear crash. The point in time at which the brakes are released is calculated using a theoretical model for the approach of a hypothetical vehicle following behind, based on assumptions for the initial distance and for a particular driving behavior of vehicle following behind 2. For this reason, collision prevention system 5 does not require any sensors for the monitoring of the space behind vehicle 1. Thus, no information is available concerning the speed v₂(t) or distance d(t) of the vehicle following behind. Even the existence of a vehicle following behind is not known. Rather, system 5 proceeds from the assumption of a typical driving behavior or driver characteristics that can be determined from statistical evaluations of traffic events.

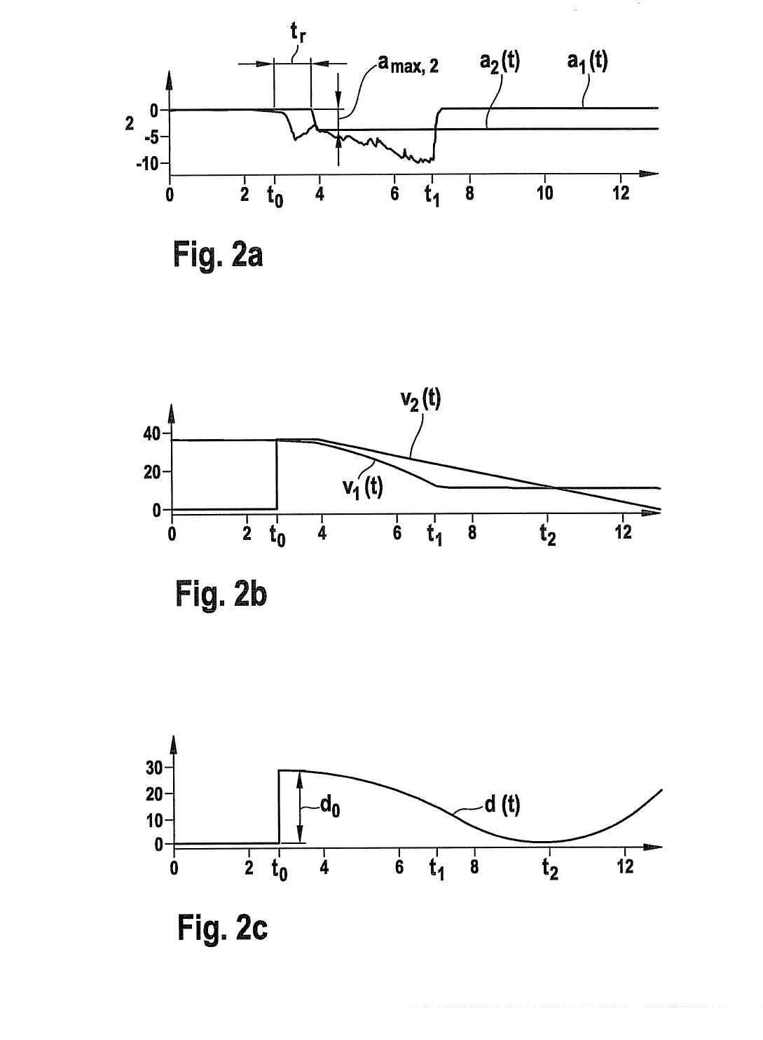

In the exemplary embodiment described below, for the behavior of vehicle following behind 2 a certain driver reaction time tᵣ, a maximum deceleration a_{max,2} of vehicle following behind 2 and a certain initial distance d₀, which is a function of the speed v₁ of the first vehicle, are assumed. The driving behavior of the two vehicles 1, 2 and the change in various driving state quantities are illustrated in FIGS. 2a-2c.

FIG. 2a shows the temporal curve of the longitudinal acceleration aₓ of the two vehicles after the activation of an automatic emergency braking, FIG. 2b shows the temporal curve of the longitudinal speeds v₁ and v₂, and FIG. 2c shows the longitudinal curve of the distance d between the two vehicles 1 and 2. In each case, the index “1” designates a quantity of the first vehicle, and “2” designates a quantity of second vehicle 2. The represented quantities of vehicle 1 can be measured using the existing sensors, and the represented quantities of vehicle 2 are calculated on the basis of the above-named assumptions, with the aid of the approach model of safety system 5.

At time t₀, an automatic emergency braking is activated. The speed v₁ of vehicle 1 is correspondingly reduced. Moreover, it is assumed that the driver of vehicle following behind 2 requires a reaction time tᵣ before he also actuates his brake. The vehicle following behind then decelerates at a_{max,2}. This acceleration a_{max,2} is here assumed to be smaller in its magnitude than that of first vehicle 1, because an average driver will usually not achieve the full physically realizable deceleration of the vehicle. As can be seen in FIG. 2b, the speed v₂ of the second vehicle reduces at a slower rate than does that of first vehicle 1. Thus, the distance d(t) between the two vehicles 1, 2 becomes ever smaller, as can be seen in FIG. 2c.

At time t₁, the brake of front vehicle 1 is automatically released in order to prevent a rear crash. First vehicle 1 subsequently continues to move with a speed v₁ that remains constant (see FIG. 2b). Here, time t₁ is calculated in such a way that at time t₂, at which the two vehicles come into contact (i.e., distance d is zero), the speeds v₁, v₂ of the two vehicles 1, 2 have equal magnitude. That is, vehicle following behind 2 approaches vehicle 1 until they come into contact, but a rear crash does not occur because at this time the two vehicles have the same speed.

Optionally, of course, a rear crash of the vehicle following behind with low energy may be tolerated, or it may also be established that the two vehicles do not come into contact at all, and that a specified minimum distance is to be maintained.

In the following, an algorithm is explained that determines a vehicle speed v₁ at which the brake must be released in order for vehicles 1 and 2 to have the same speed at the time of contact, so that a collision is just barely prevented.

The algorithm proceeds on the assumption that the two vehicles 1, 2 are traveling at the same speed before the automatic braking. In normal vehicle traffic, this is generally approximately the case. After a reaction time tᵣ, the vehicle then decelerates with a_{max,2}. Thus, for speed v₂ of vehicle following behind 2, the following holds (for t>t₀+tᵣ):

v₂(t)=v₀+Int(a_{max,2}(t))·dt. (1)

Here, v₀ is the speed of the two vehicles 1, 2 at the beginning of the automatic braking.

The relative speed of the two vehicles thus results from:

vᵣₑₗ(t)=vᵢ(t)−v₂(t) (2)

where v₁ can be measured directly in vehicle 1.

Subsequently, the relative speed is numerically integrated, resulting in the reduction d_{red}(t) of the distance between the two vehicles:

d_{red}(t)=Int(vᵣₑₗ(t))·dt (3)

The remaining distance d(t) thus results as:

d(t)=d₀+d_{red}(t). (4)

Because vehicle following behind 2 is moving faster, due to the lesser deceleration a_{x,2}, than the first vehicle, d_{red}(t) is less than zero. Thus, the remaining distance d(t) decreases.

As was described above, for release speed v_{L} it was defined that the two vehicles should just come into contact and, at the imagined time of contact t₂, should have the same speed. For the time of contact dt, assuming a constant deceleration of the vehicle following behind, the following should thus hold:

v₁(dt)=v₂(dt)=v₂(tₐₖₜ)+a_{x,2}(tₐₖₜ)·dt (5)

Here, v₂(tₐₖₜ) is the theoretically assumed current speed of vehicle following behind 2 at current time tₐₖₜ. If the current distance d(tₐₖₜ) of the two vehicles should be reduced to zero after a time dt, the following equation may be used for the difference in the distance traveled by the two vehicles 1, 2:

v₂(tₐₖₜ)·dt+½·a₂(tₐₖₜ)·dt²−v₁(tₐₖₜ)·dt=d(tₐₖₜ) (6)

From the two equations (5), (6), the time until contact is obtained,

dt=−1/a₂(tₐₖₜ)·{square root over ((−2·a₂(tₐₖₜ)·d(tₐₖₜ)))} (7)

and the speed vL of first vehicle 1 at which the brake must be released results as:

V_{L}=V₂(tₐₖₜ)−\sqrt{−2·a₂(tₐₖₜ)·d(tₐₖₜ)} (8)

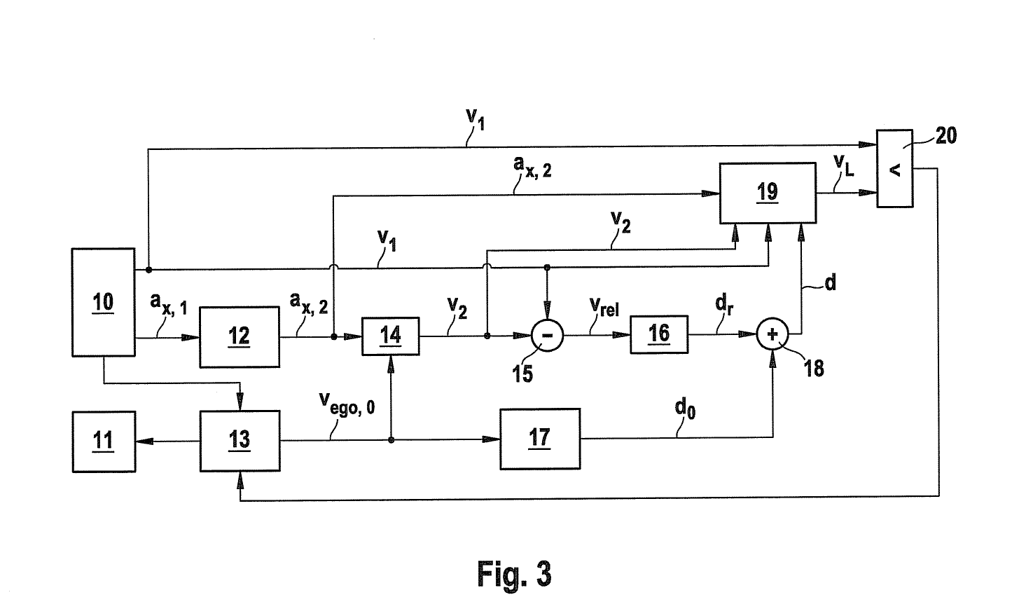

FIG. 3 shows a schematic block diagram of a collision prevention system having an algorithm for reducing the danger of a rear crash. The overall system 5 includes various sensors 10 for monitoring the space in front of first vehicle 1, such as radar sensors, as well as wheel rotational speed sensors. Those sensor signals that are necessary for the activation of an automatic braking are read out by a safety function 13. When a critical driving situation occurs, braking system 11 is automatically actuated by function 13.

A unit 12 calculates, for example on the basis of the deceleration of vehicle 1, and if necessary the estimated frictional value assuming a reaction time, a theoretical deceleration a_{x,2} of the assumed vehicle following behind 2. The latter quantity is integrated according to Equation (1), using an integrator 14, and in this way a speed v₂ of vehicle following behind 2 is calculated, taking into account the initial speed. Speeds v₁ and v₂ are supplied to a unit 19 for calculating the release speed v_{L} according to Equation (8). From the difference in the two speeds v₁ and v₂, calculated at a node 15, the relative speed vᵣₑₗ results, which is integrated by an integrator 16 in order to calculate the change in the distance d of the two vehicles 1, 2 according to Equation (3). From this value d_{red} and from an initial distance d₀ determined by a unit 17, the momentary distance d of the two vehicles 1, 2 results (see Equation (4)). The latter quantity is also supplied to unit 19, which calculates release speed v_{L} from the various input quantities. When speed v₁ of the front vehicle reaches release speed v_{L}, the braking process is automatically interrupted. Front vehicle 1 then continues to move with a constant speed.

1-7. (canceled)

8. A method for preventing a possible collision after activation of an automatic braking intervention by a vehicle safety system, the method comprising:
in a first phase of the automatic braking intervention, carrying out a braking with a high braking moment;
determining a condition for a release of a brake with application of a model for an approach of a hypothetical vehicle following behind; and
when the condition is met, at least partially releasing the brake in order to prevent a rear crash or to limit a severity thereof.

9. The method according to claim 8, wherein the model assumes an initial distance of the vehicle following behind from a home vehicle, and determines the release condition as a function of the distance.

10. The method according to claim 8, wherein the model assumes an initial speed of the vehicle following behind, and determines the release condition as a function of the speed.

11. The method according to claim 8, wherein the model assumes a theoretical reaction time of a driver of the vehicle following behind, and determines the release condition as a function of the reaction time.

12. The method according to claim 8, wherein the model assumes a theoretical deceleration of the vehicle following behind, and determines the release condition as a function of the deceleration.

13. The method according to claim 8, wherein the release condition is selected such that after the release of the brake a certain distance between the two vehicles is not undershot, or that at a time at which the two vehicles come into contact a certain difference in speeds of the vehicles is not exceeded.

14. A control device for preventing a possible collision after activation of an automatic braking intervention by a vehicle safety system, the control device comprising means for performing the following:
in a first phase of the automatic braking intervention, carrying out a braking with a high braking moment;
determining a condition for a release of a brake with application of a model for an approach of a hypothetical vehicle following behind; and
when the condition is met, at least partially releasing the brake in order to prevent a rear crash or to limit a severity thereof.
